(19) United States
(12) Patent Application Publication
(10) Pub. No.: US 2003/0112810 A1
(43) Pub. Date: Jun. 19, 2003

(54) Method for forwarding packets by connecting network segments through a wireless channel and wireless bridging apparatus using the same

(76) Inventors: Sumie Nakabayashi, Kokubunji (JP); Hirotake Wakai, Kodaira (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/310,819

(22) Filed: Dec. 6, 2002

(30) Foreign Application Priority Data
Dec. 14, 2001 (JP) 2001-381952

(51) Int. Cl. H04L 12/28

(52) U.S. Cl. 370/401; 370/338

(57) ABSTRACT

A wireless bridge selects wireless bridges, each with communication quality at a predetermined level or higher, from other wireless bridges, which are located in a range where the wireless bridge can communicate, as wireless bridges to which a spanning tree protocol (STP) is applied. The wireless bridge adds a MAC header, where a broadcast or multicast address is a forwarding destination address, to a packet to be multicast to a plurality of wireless bridges and transmits the packet from a wireless interface as a multicast-service packet.

### BACKGROUND OF THE INVENTION

The present invention relates to a wireless bridging scheme for connecting a plurality of network segments through a wireless channel, and more particularly to a method and a wireless bridging apparatus for selectively performing individual communications and multicasting service with other remote wireless bridging apparatuses.

A wireless bridging apparatus (hereinafter called a wireless bridge) is known as an apparatus that connects a plurality of network segments, each of which is a wired LAN, via wireless channels and that converts packets generated in a segment into packets for wireless transmission and forwards the converted packets to other network segments. As an inter-bridge communication protocol for use in a wired LAN, the Spanning Tree Protocol (STP) defined by IEEE802.1D, pp. 58-62, 1998is known. The disclosure of IEEE802.1D is hereby incorporated by reference.

The STP requires the input/output ports of a bridge to send and receive BPDU (bridge protocol data unit) frames and, for each port, to collect identification information on destination bridges and path cost information representing the path speed from the root bridge to identify the network topology. If the network includes a loop path, one of the bridges on the loop path blocks a high-cost path to configure a tree network with the root bridge at the top. A redundant path removed from the network remains included in the network as a bypass circuit for use when an error occurs and the main path is not available. A bridge with the STP function learns about the MAC address of a packet received at each port to forward the received packet to an appropriate network segment corresponding to the destination address.

A conventional bridge, which has the STP function described above, has an STP protocol processor that controls packet forwarding to or from each port. This bridge determines the received-packet forwarding destination output port assuming that a particular network segment is connected to each port.

However, a wireless bridge can communication with a plurality of neighboring wireless bridges through one wireless interface. IEEE802.11, pp. 70-74, 1999, the disclosure of which is hereby incorporated by reference, specifies that CSMS/CA (Carrier sense multiple access with collision avoidance) be used for access control in a wireless section. When transmitting data to a wireless section, the wireless bridges each can specify the MAC address of a forwarding destination wireless station in the header of a transmission packet so that the wireless line may be multiply accessed. That is, because one wireless interface corresponds physically to a plurality of wireless stations, it is difficult to apply the STP, originally designed for use with the one-network-segment/one-port relation, even if the conventional STP protocol processor attempts to set up a path between the local bridge and other wireless bridges.

Therefore, the wireless interface requires a port management that is different from that of a wired LAN interface where each port is connected to a specified network segment. This is described in Technical Report of IEICE RCS99-24 (1999-05), pages 63-68. This report proposes a method in which a logical port is allocated to each partner of communication through the wireless interface of an STP-conforming wireless bridge and, when a frame is received from the wireless interface, the TA (Transmitter Address) included in the frame header is checked to identify the logical port.

In addition, JP-A-2000-253037 discloses a conventional technology for wireless packet forwarding between wireless bridges that transfer packets based on the STP.

### SUMMARY OF THE INVENTION

As described in Technical Report of IEICE RCS99-24 (1999-05), allocating a logical port to each destination of communication through the wireless interface allows one wireless interface to selectively communicate with a plurality of different wireless bridges using the conventional STP protocol processor function.

When a packet is communicated in the wireless air space, a MAC header is added to a packet frame, for example, an Ethernet frame forwarded over a wired LAN forming a network segment, with the forwarding destination bridge specified in the MAC header. Therefore, a wireless bridge converts a transmission packet, which is distributed to each logical port by the STP protocol processor, into a MAC frame specifying a forwarding destination bridge unique to each logical port and forwards the converted frame to another wireless bridge through the wireless interface. On the other hand, upon receiving a packet from the wireless interface, a wireless bridge checks the forwarding destination bridge address and, if the packet is addressed to the bridge itself, receives the packet. In this way, the STP protocol processor controls forwarding in the bridge.

Therefore, in the multicasting service where a same-content packet is transmitted at a time to a plurality of terminals such as in broadcasting or multicasting, the STP protocol processor in accordance with the conventional technology forwards a copy of the same-content packet to a plurality of wireless-interface logical ports and transmits a plurality of MAC frames, each of which has a forwarding destination address that differs from logical port to logical port, from the wireless interface. Each forwarding destination wireless bridge receives the MAC frame addressed to itself and forwards the original broadcast packet, extracted from the received MAC frame, to the LAN segment. In this case, the forwarding-source wireless bridge repeatedly sends a plurality of MAC frames each having a unique forwarding-destination address. This increases the traffic in the wireless section and decreases the message transfer efficiency of each wireless bridge.

Another problem is that communication quality in a wireless section depends on a change in the environment. Therefore, when the logical ports described above are allocated permanently to a plurality of neighboring wireless bridges located in a range where the wireless bridge can communicate, a message retransmission request would be generated frequently if a reception error is caused because of degraded communication quality. This also results in an increase in the traffic in the wireless section and a decrease in message transfer efficiency.

It is an object of the present invention to provide a message forwarding method and a wireless bridging apparatus that efficiently forward messages in a wireless section.

It is another object of the present invention to provide a wireless bridging apparatus that efficiently allocates logical ports to a wireless interface.

It is still another object of the present invention to provide a wireless bridging apparatus that can efficiently transmit multicasting service packets such as those used in broadcasting and multicasting.

It is still another object of the present invention to provide a wireless bridging apparatus adaptable to a dynamic change in the network topology.

To achieve the above objects, a wireless bridge according to one aspect of the present invention selects wireless bridges, each with communication quality at a predetermined level or higher, from other wireless bridges, which are located in a range where the wireless bridge can communicate, as connectable bridges to which a spanning tree protocol (STP) is applied. The wireless bridge adds a MAC header, which includes a broadcasting address or a multicasting address as a forwarding destination address, to a packet to be broadcast or multicast to a plurality of wireless bridges and transmits the packet from a wireless interface as a multicasting-service packet.

According to another aspect of the present invention, there is provided a wireless bridge comprising means for selecting wireless bridges from other remotely-located wireless bridges, with which the wireless bridge can communicate, based on communication quality and for allocating logical port identifiers to the connected wireless bridges; a plurality of transmission and reception buffers provided for a port number allocated to the network segment of the bridge and for the logical port identifiers; a forwarding controller for forwarding a packet stored in each of the reception buffers to a transmission buffer identified by a destination address; and means for transmitting and receiving packets to or from other network segments via the transmission and reception buffers.

In accordance with still another preferred feature of the present invention, a broadcasting or multicasting packet is transmitted at a time to a plurality of connected bridges by providing a multicasting-service transmission buffer corresponding to a particular logical port identifier.

According to still another aspect of the present invention, there is provided a wireless packet forwarding method using a wireless bridge. The method comprises the steps of selecting wireless bridges, each with communication quality at a predetermined level or higher, from other wireless bridges, which are located in a range where the wireless bridge can communicate, as the wireless brides to which a spanning tree protocol is applied; adding a MAC header, which includes a broadcasting address or a multicasting address as a forwarding destination address, to a packet to be transmitted to a plurality of wireless bridges through a multicasting service; and transmitting the packet from a wireless interface of the wireless bridge as a multicasting-service packet.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing an example of a wireless LAN to which a wireless bridge according to the present invention is applied.

FIG. 2 is a diagram showing the format of a MAC frame transferred between wireless bridges.

FIG. 3 is a diagram showing the format of a BPDU (Bridge Protocol Data Unit) transferred between wireless bridges to identify the network topology.

FIG. 4 is a diagram showing an embodiment of a wireless bridge according to the present invention.

FIG. 5 is a diagram showing the configuration of a routing table 20 included in FIG. 4.

FIG. 6 is a diagram showing the configuration of a parameter table 30 included in FIG. 4.

FIG. 7 is a diagram showing the configuration of a multicasting-service address table 41 included in the address table 40 in FIG. 4.

FIG. 8 is a diagram showing the configuration of a connection table 50 included in FIG. 4.

FIG. 9 is a diagram showing an example of an STP topology corresponding to the wireless LAN shown in FIG. 1.

FIG. 10 is a diagram illustrating the forwarding operation of a packet by the wireless bridge according to the present invention.

FIG. 11 is a flowchart showing the function of a packet transmission processing routine 64.

### DESCRIPTION OF THE EMBODIMENTS

A wireless bridge according to the present invention that is applied to an IEEE802.11 standard wireless LAN will be described below. IEEE802.11 is a standard for the physical layer and the MAC (Media Access Control) layer of a wireless LAN. The MAC layer corresponds to the lower part of the data link layer of the OSI (Open System Interconnection) reference model.

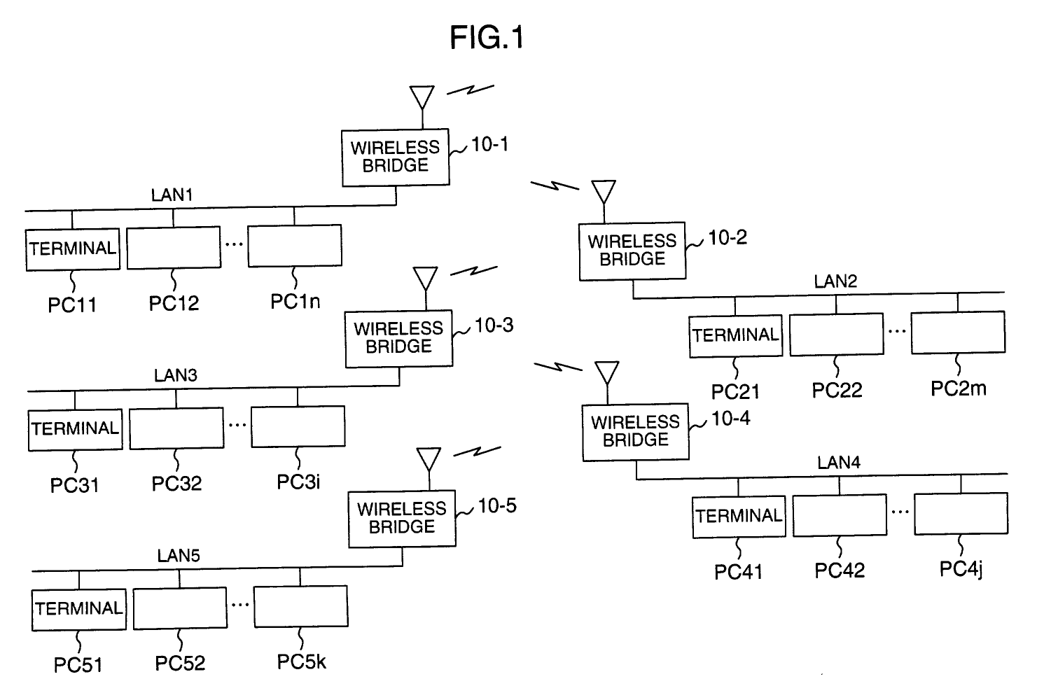

FIG. 1 shows an example of a wireless LAN to which the wireless bridge according to the present invention is applied.

The wireless LAN comprises a plurality of wireless bridges 10-i (i=1-5). A wireless bridge 10-i, each connected to a plurality of terminals PCi1, PCi2, and so on, via a wired LANi, to form a network segment.

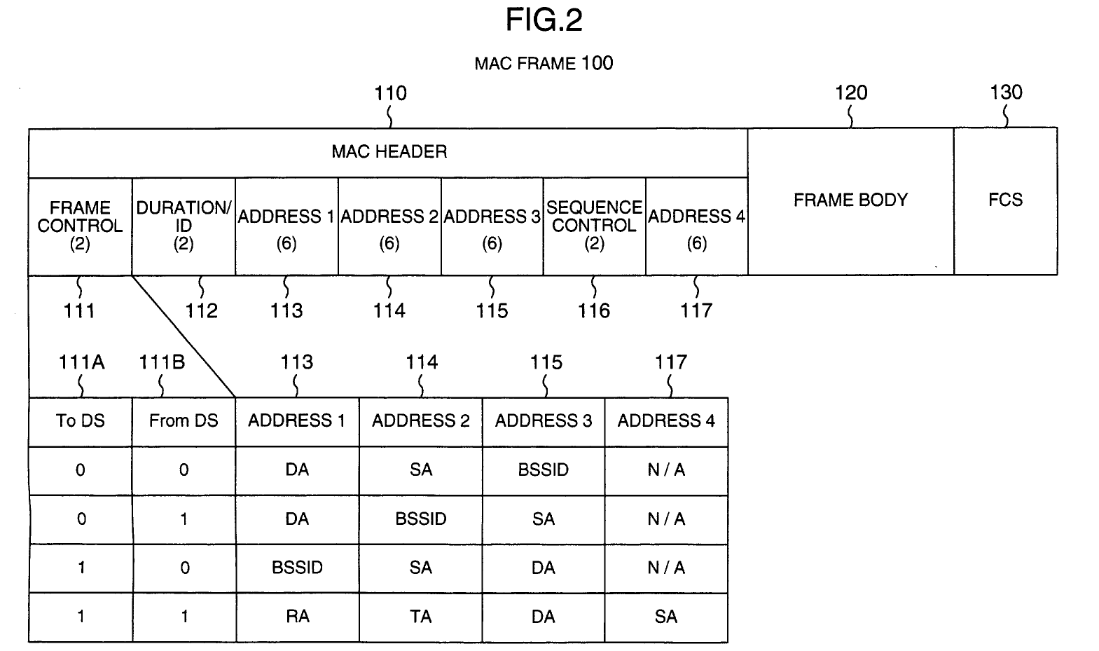

FIG. 2 shows the format of an IEEE802.11-conforming MAC frame 100 communicated between wireless bridges in the wireless LAN described above.

The MAC frame 100 is composed of a MAC header 110, a frame body 120, and an FCS (Frame Check Sequence) 130. The frame body 120 includes a packet, for example, an Ethernet frame, communicated over each wired LAN (network segment).

The MAC header 110 is composed of seven fields: frame control information 111, duration/ID information 112 indicating the time required until the completion of transmission (duration time: Duration/ID), address 1:113, address 2:114, address 3:115, sequence control information 116, and address 4:117.

A numeral in parentheses indicates the length (number of octets) of each field, and each address field contains a 6-octet MAC address. The three high-order octets of an MAC address indicate a code unique to a communication equipment manufacturer, and the remaining three octets indicate a value unique to the communication equipment or interface.

The contents of an address in the address fields 113, 114, 115, 116, and 117 depend on the combination of the “To DS” bit and the “From DS” bit included in the frame control information 111. DS, the abbreviation for Distribution System, means a part of connection with a LAN not conforming to IEEE802.11, for example, a connection interface with a wired LAN.

When the wireless bridge 10 forwards a packet between wired LANs, the address fields contain the following addresses as shown in the column of the bottom table in FIG. 2 where the “To DS” bit is “1” and the “From DS” bit is “1”; that is, the address field 114 contains the transmitting source (forwarding source) MAC address TA (transmitter address) in the wireless section, the address field 113 contains the destination (forwarding destination) MAC address RA (receiver address) in the wireless section, the address field 117 contains the MAC address SA (source address) of the packet transmitting source terminal, and the address field 115 contains the MAC address DA (destination address) of the packet destination terminal.

Each wireless bridge references the TA address and the SA address included in the MAC header attached to a packet received from the wireless interface to identify the MAC addresses of the connection wireless bridge and the terminal corresponding to each logical port.

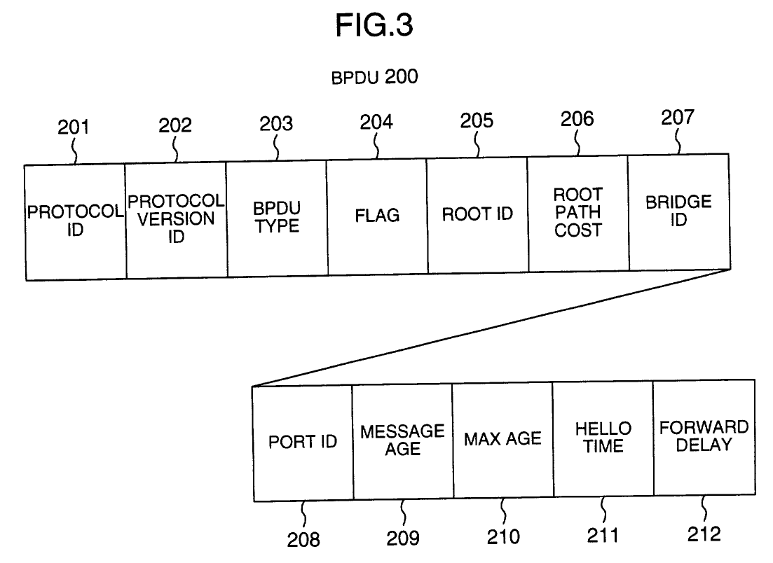

FIG. 3 shows the format of a BPDU (bridge protocol data unit) frame 200 transferred between wireless bridges in order to identify the network topology.

The BPDU frame 200 is composed of a protocol ID 201, protocol version ID 202, BPDU type 203, flag 204, root ID 205, root path cost 206, bridge ID 207, port ID 208, message age 209, MAX age 210, hello time 211, and forward delay 212.

With the wireless bridge with the lowest bridge priority value in the network as the root bridge, the STP transmits the BPDU frame 200 described above from the ports of the root bridge. Upon receiving the BPDU frame 200, a bridge connected to the root bridge adds its own root port path cost to the root path cost 206 in the received BPDU frame 200 and forwards the received BPDU frame 200 to another bridge. Each bridge references the root path cost 206 of the BPDU frame 200 received from the ports of the bridge to determine the best path to the root bridge. If a redundant path is found, the bridge blocks a high path-cost port to set an effective path.

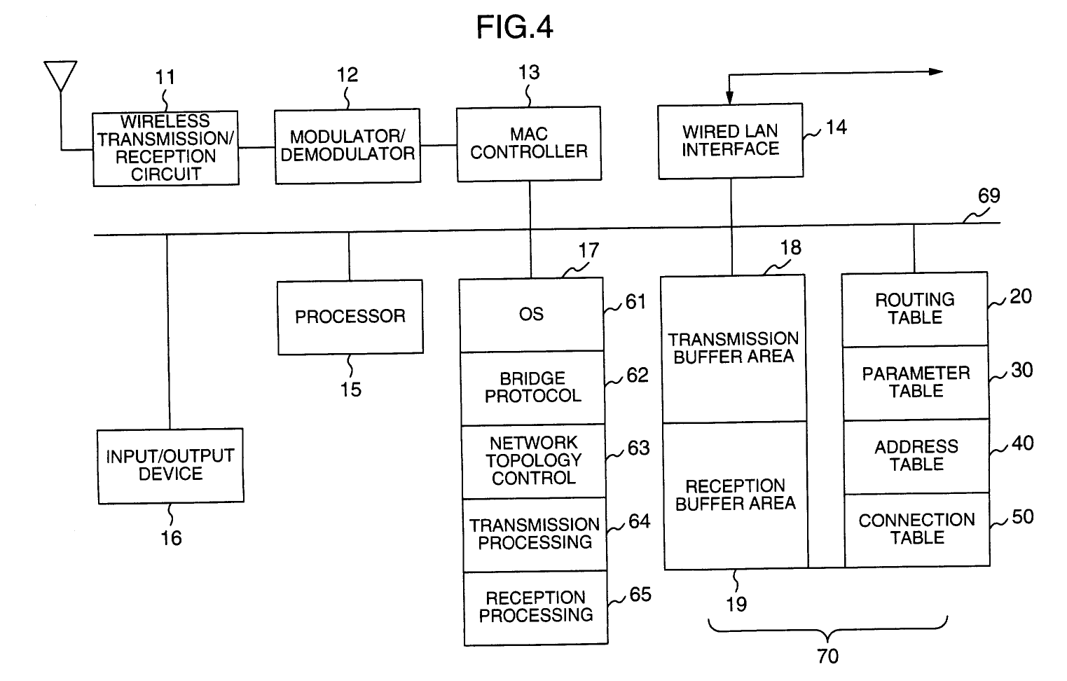

FIG. 4 shows an embodiment of a wireless bridge 10 according to the present invention.

The wireless bridge 10 comprises a wireless transmission/reception circuit 11, modulator/demodulator 12, MAC controller 13, wired LAN interface 14 connected to the network segment of the bridge, processor 15, input/output device 16 acting as a user interface, program storage memory 17, and data storage memory 70.

The data storage memory 70 contains a transmission buffer area 18, reception buffer area 19, routing table 20, parameter table 30, address table 40, and connection table 50. The program storage memory 17 contains an OS (Operating System) 61 and major programs associated with the present invention, such as a bridge protocol processing routine 62, network topology control routine 63, transmission processing routine 64, and reception processing routine 65.

The processor 15 is connected to the modulator/demodulator 12, MAC controller 13, and wired LAN interface 14 via an internal bus 69. As will be described later, the processor 15 executes the bridge protocol processing routine 62, transmission processing routine 64, and reception processing routine 65 to control the forwarding of packets between the MAC controller 13 described above and the wired LAN interface 14. In addition, the processor 15 works with the MAC controller 13 and executes the network topology control routine 63 to collect the network topology information and updates the table information to implement the functions such as wireless bridge path setting, network error detection, and bypass setting.

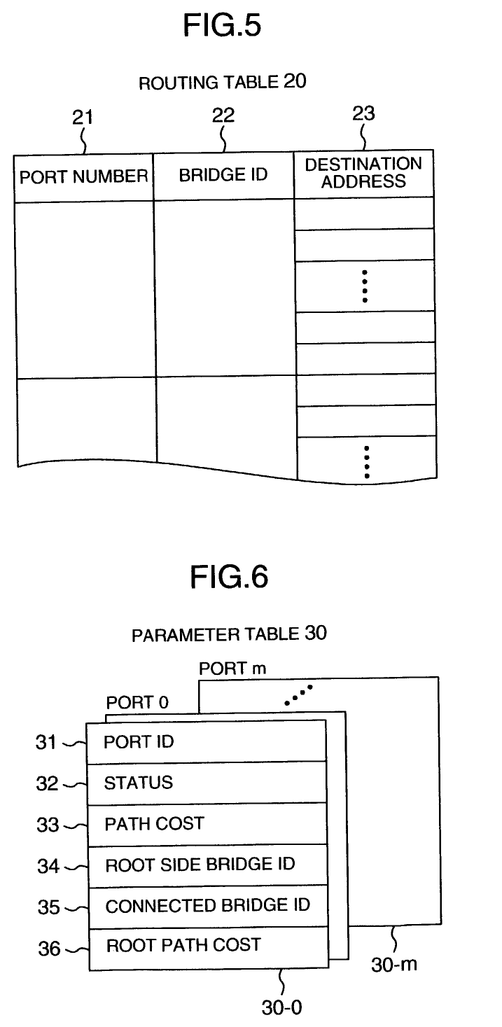

FIG. 5 shows the configuration of the routing table 20.

The routing table 20 contains information on the correspondence among a port number 21, bridge ID 22, and destination addresses (terminal addresses) of a plurality of input/output ports of a wireless bridge. For each port number 21, the ID 22 of a connected bridge and the addresses (destination addresses) 23 of a plurality of terminals existing in the direction of the connected bridge are stored.

For the wireless interface, that is, for the circuit composed of the wireless transmission/reception circuit 11, modulator/demodulator 12, and MAC controller 13, the port number field 21 contains two types of logical port numbers: a logical port number allocated to the connected bridge and logical port numbers allocated for the multicasting service (broadcast/multicast) that will be described later. The connected bridge ID field 22 corresponding to a port number for the multicasting service contains a meaningless value, and the destination address field 23 contains broadcasting/multicasting addresses.

FIG. 6 shows the configuration of the parameter table 30.

The parameter table 30 is composed of a plurality of sub-tables 30-0 to 30-m each corresponding to the port number 21 stored in the routing table 20 described above.

A sub-table 30-i contains parameter information including a port ID 31, status 32, path cost 33, root side bridge ID 34, connected bridge ID 35, and root path cost 36.

The port ID 31, which is the ID identifying a port in the wireless bridge 10, includes a real port ID (port number) allocated to the wired LAN interface 14 and a plurality of logical port IDs (logical port numbers) allocated to the wireless interface.

The status 32 indicates the current status of the port in one of four status codes: Listening, Learning, Forwarding, and Blocking.

“Listening” is the status in which the bridge is sending and receiving the BPDU for setting the network topology and the best path. If a path higher in priority than the path corresponding to the port is found in the Listening status, the port transits to the Blocking status and data transfer from that port is blocked. If a path higher in priority than the path corresponding to the port is not found in Listening status, the port transits to the Learning status and the path information is stored in the Forwarding Table. When a predetermined time (Forward Delay Time) has passed in the Leaning status, the port transits to the Forwarding status and normal data transfer is performed on that port.

The path cost 33 represents the communication speed of the interface connected to the port. Generally, the higher the interface communication rate, the smaller the path cost value. For example, IEEE802.1D recommends that the path cost of the interface speed of 10 Mb/s be “100” and that the path cost of the interface speed of 100 Mb/s be “19”.

A bridge ID value that is stored in the root side bridge ID field 34 and the connected bridge ID field 35 is a combination of the bridge priority and the bridge MAC address. A bridge with the lowest bridge priority in the network is the root bridge. The root side bridge ID field 34 contains the ID of the bridge that is adjacent to the port and is in the root side of the port in the network topology. The connected bridge ID field 35 contains the ID of the bridge actually connected to the port or the ID of a neighboring wireless bridge corresponding to the logical port.

The root path cost 36 indicates the total of path costs from the root bridge to the port. This value is determined from the BPDU frame described above.

The address table 40 consists of two tables: a table for the address (hereinafter called local address) allocated to the wireless bridge and a multicasting-service address table.

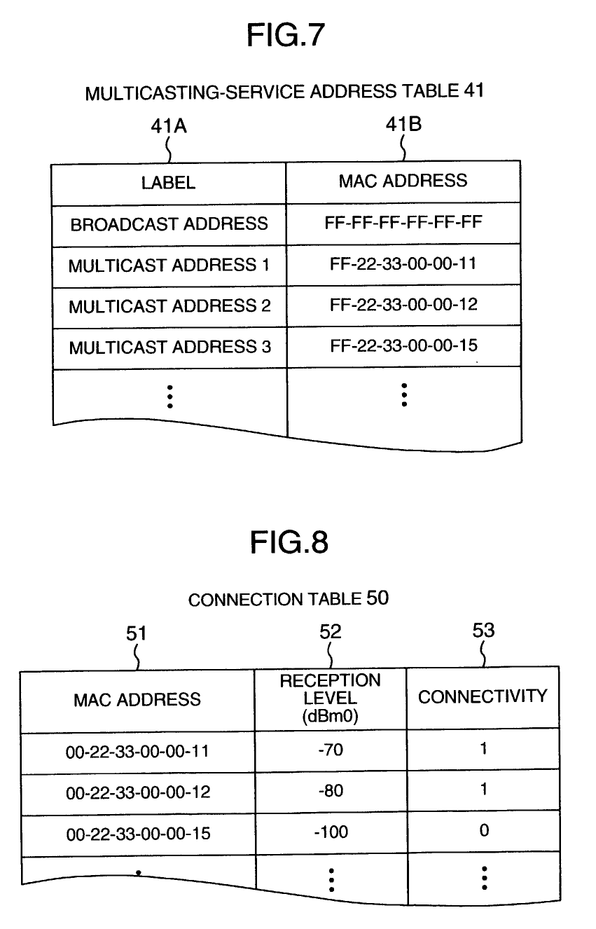

FIG. 7 shows the multicasting-service address table 41.

The multicasting-service address table 41 consists of a column with a label 41A indicating the distinction between broadcasting and multicasting and a column with a label 41B containing multicasting MAC address values effective for the bridge.

The wireless bridge 10 uses the reception processing routine 65, which will be described later, to compare the forwarding destination address RA in a MAC frame received from the wireless interface with the addresses stored in the address table 40. If the forwarding destination address RA matches the local address or one of multicasting service addresses, the received frame is passed to the bridge protocol processing routine 62 for transfer to the port indicated by the destination address. For a packet that is output by the bridge protocol processing routine 62 to the multicasting-service logical port, the destination address is compared with the multicasting service addresses in the multicasting-service address table 41 as will be described later. If an address match is found, the multicasting-service MAC header is added to the packet and the packet is forwarded to the wireless interface.

FIG. 8 shows the configuration of the connection table 50.

The connection table 50, provided for identifying other wireless bridges (connected bridges) with which to communicate via the wireless interface, consists of a MAC address field 51 containing other wireless bridges located in the range where packets may be sent and received, a signal reception level field 52, and a connectivity flag information 53.

The wireless bridge 10 according to the present invention checks the other neighboring wireless bridges if the signal reception level is higher than a predetermined threshold and, as a result of this checking, determines only those wireless bridges satisfying the signal level as connectable wireless bridges. The wireless bridge 10 selects those wireless bridges as STP-applicable bridges, allocates the logical port numbers to them, and generates the parameter sub-tables 30.

That is, immediately after initialization, the wireless bridge 10 according to the present invention scans the neighboring wireless bridges to detect those with which communication may be performed. The known methods for scanning the neighboring wireless bridges include a passive scan and an active scan. In the passive scan method, the beacon frames generated by the neighboring wireless bridges are monitored regularly to detect wireless bridges with which communication may be performed. In the active scan method, an initialized wireless bridge sends a probe frame and, upon receiving the probe response frame from the neighboring wireless bridges, detects wireless bridges with which communication may be performed.

When the active scan method is used, the wireless signal of the probe response frame from a neighboring other wireless bridge is received by the wireless transmission/reception circuit 11 shown in FIG. 4, demodulated by the modulator/demodulator 12, input to the MAC controller 13 as an MAC frame, and then sent to the processor 15. The reception level of the wireless signal is measured, for example, by the modulator/demodulator 12 and is sent to the processor 15 via the MAC controller 13. A beacon frame received in the passive scan method and the reception level of the wireless signal measured by the modulator/demodulator 12 are also sent to the processor 15 via the MAC controller 13 as the same way described above. The reception level may also be sent directly from the modulator/demodulator 12 to the processor 15.

The processor 15 executes the network topology control routine 63 (FIG. 4) at initialization time, analyzes the scan result of the neighboring wireless bridges, and generates the connection table 50 indicating the relation between the MAC addresses and the reception levels of the neighboring wireless bridges.

The network topology control routine 63 sorts the entries in the connection table 50 in the descending order of reception levels and, for the neighboring wireless bridges whose reception level is higher than the predetermined threshold level, sets the connectivity flag information 53 to the connectable state. For the wireless bridges with the reception level lower than the threshold, the network topology control routine 63 sets the connectivity flag information 53 to non-connectable state to remove it from processing by the STP. In this case, the upper limit of the number of connectable wireless bridges may be set in order to prevent the generation of unnecessary traffic. This allows the network topology control routine 63 to select a limited number of wireless bridges from the wireless bridges with a reception level equal to or higher than the threshold in descending order of reception level.

The scan data of the neighboring wireless bridges described above may be collected by issuing a command from the processor 15 to the MAC controller 13, for example, with the wireless LAN media access controller HFA3841 from Intersil (Registered trademark) as the MAC controller 13. Scan data may be collected not only at initialization time but also regularly to ensure adaptability to a dynamic change in the network topology. HFA3841 is a MAC control LSI conforming to IEEE802.11 and the procedures of the active and passive scans are disclosed by IEEE802.11, pp. 101-103 and 125-127, the disclosure of which is hereby incorporated by reference.

According to the present invention, each wireless bridge selects particular wireless bridges as connectable bridges based on the reception level described above and then allocates logical port IDs to, and generates parameter sub-tables for, those wireless bridge to execute the topology control operations such as path setting.

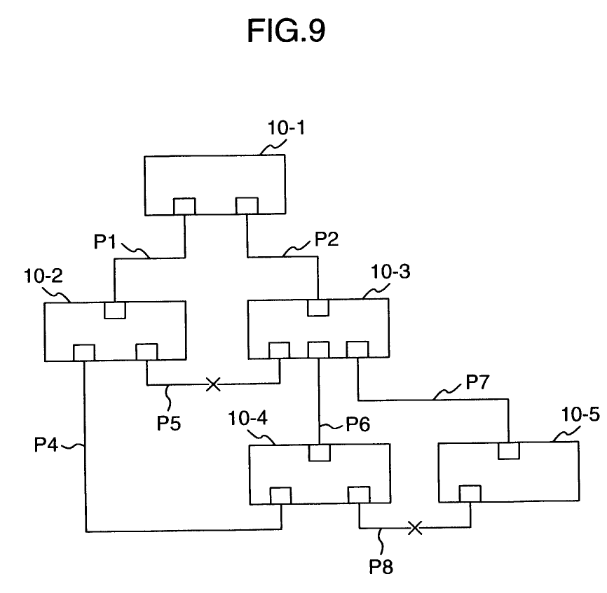

For example, in the wireless LAN shown in FIG. 1, assume that the wireless bridge 10-1 selects the wireless bridges 10-2 and 10-3 as the connectable bridges, that the wireless bridge 10-2 selects the wireless bridges 10-1, 10-3, and 10-4, that the wireless bridge 10-3 selects the wireless bridges 10-1, 10-2, 10-4, and 10-5, that the wireless bridge 10-4 selects the wireless bridges 10-2, 10-3, and 10-5, and that the wireless bridge 10-5 selects the wireless bridges 10-3 and 10-4, respectively. If the wireless bridge 10-1 becomes the root bridge because of the priority of the bridges and if a plurality of logical ports in each bridge have the same path cost, then the STP topology of the wireless LAN shown in FIG. 1 is as shown in FIG. 9.

Each wireless bridge 10-i (i=1-5) evaluates the root path cost of each logical port in the bridge according to the STP protocol processing function and blocks a redundant path. As a result, the logical port connected to a path P5 between the bridges 10-2 and 10-3 and the logical port connected to a path P8 between the bridges 10-4 and 10-5 are blocked. This status is reflected in the parameter table.

Because the root path cost of a path P4 between bridges 10-2 and 10-4 equals the root path cost of a path P6 between the bridges 10-3 and 10-4, the forwarding port is selected in the bridge 10-4, to which those paths are connected, in ascending order of the connected bridge ID and the port ID. For example, if the ID of the bridge 10-3 is smaller than the ID of the bridge 10-2, the connection port of path P4 is blocked.

However, in some cases, the path P6 should be blocked instead of the path P4 in the bridge 10-4 considering the load balance of the whole system. For example, in such a case, the path cost of the physical wireless interface should be corrected in each wireless bridge according to the number of logical ports corresponding to the physical wireless interface. The resulting value is used as the path cost of each logical port.

For example, in the bridge 10-2 where one wireless interface corresponds to three logical ports, the path cost of each logical port is set to 100. On the other hand, in the bridge 10-3 where one wireless interface corresponds to four logical ports, the path cost of the logical port is set to a value higher than that of the bridge 10-2, for example, 150. This makes the root path cost of the path P4 smaller than the root path cost of the path P6, thereby causing the bridge 10-4 to select the path P4 and to block the path P6.

If the logical port IDs are assigned in the descending order of the reception level of the signals from the connection wireless bridge, a path with the smaller port ID is selected from a plurality of paths with the same path cost. This allows a good line-condition path to be selected as a forwarding port with a bad line-condition path automatically blocked.

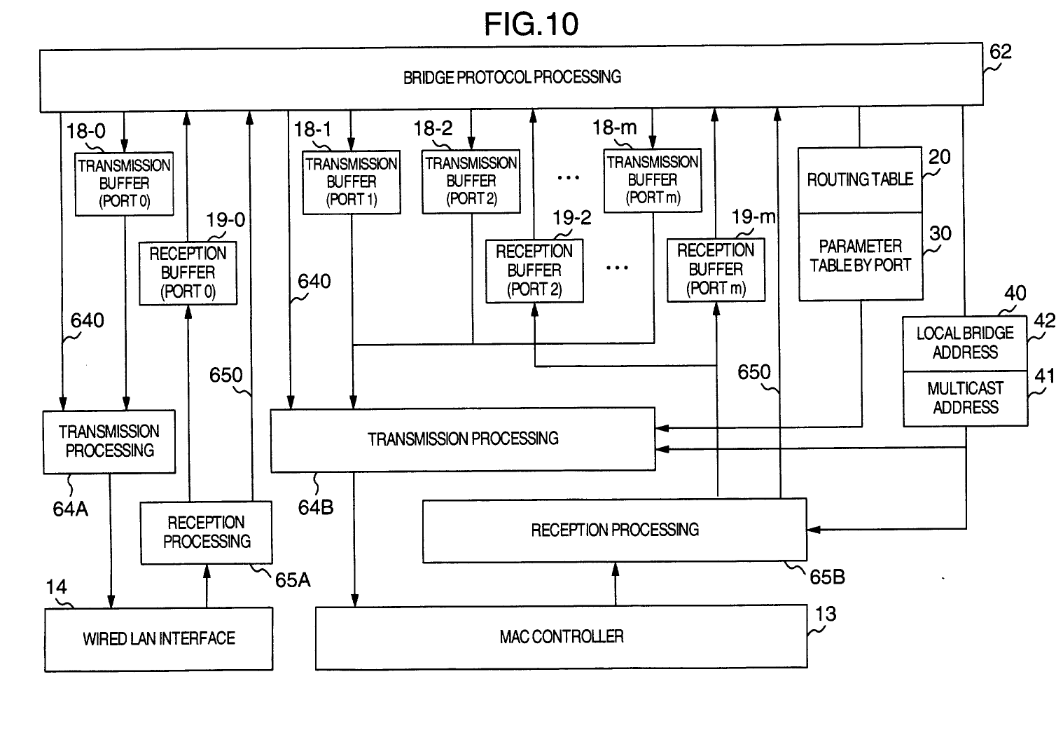

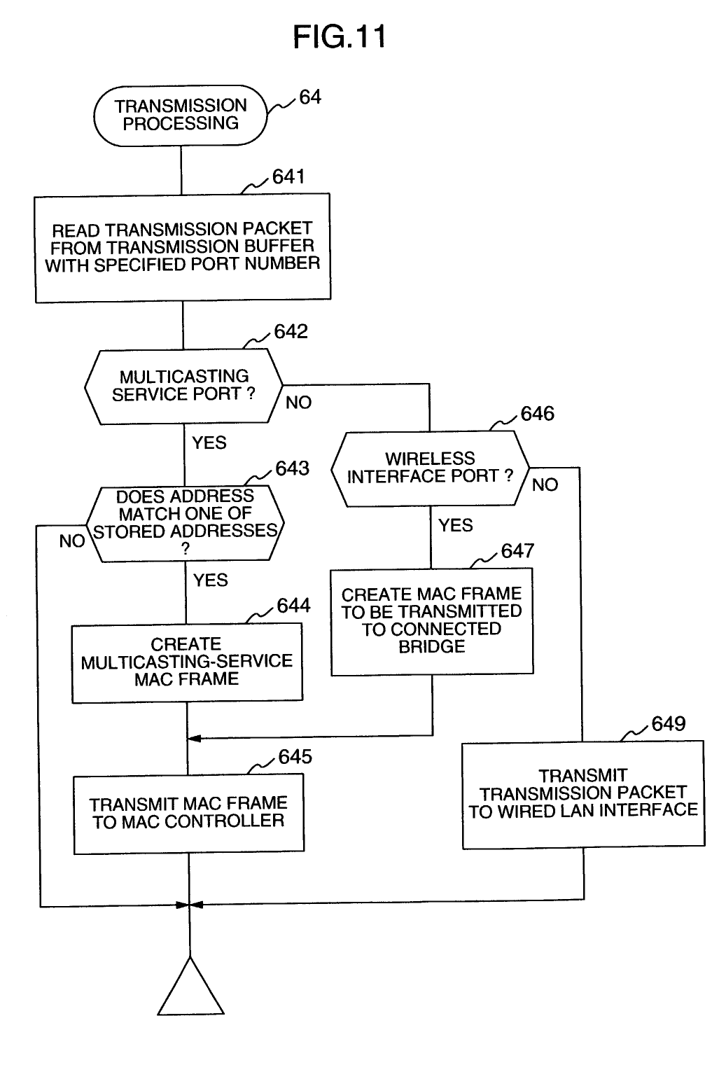

With reference to FIGS. 10 and 11, the packet forwarding operation in the wireless bridge 10 according to the present invention will be described.

FIG. 10 shows the relation among the bridge protocol processing routine 62, transmission buffer area 18, reception buffer area 19, transmission processing routine 64, reception processing routine 65, and tables 20-40 shown in FIG. 4.

In the transmission buffer area 18 and the reception buffer area 19, a transmission buffer and a reception buffer are created for each port; that is, a transmission buffer 18-0 and a reception buffer 19-0 are created for port 0 , . . . , a transmission buffer 18-m and a reception buffer 19-m are created for port m.

In this embodiment, in order to simplify the allocation of logical port numbers to connected bridges, the port number 0 is allocated to the wired LAN interface 14, the logical port number 1 is allocated to the multicasting service (broadcasting/multicasting), and the logical port numbers 2-m are allocated to the communication with other wireless bridges connected via the wireless interface. Note that there is no limitation on the order of port number allocation.

Because only the transmission buffer is required for the multicasting service (broadcasting/multicasting), the reception buffer for the port number 1 is omitted in the figure. In FIG. 10, the transmission and reception processing routines 64 and 65 are each divided into two for the convenience of illustration; that is, transmission and reception processing routines 64A and 65A for the wired LAN, and transmission and reception processing routines 64B and 65B for the wireless interface (MAC controller 13).

The bridge protocol processing routine 62 (hereinafter called bridge protocol processor), which has the STP function defined by IEEE802.1D, learns about the MAC addresses in the packets received through the wired LAN interface 14 and the wireless interface (MAC controller) 13. The routine stores the relation among the port number of each interface, the connected bridge ID, and the transmitting source address of the received packets in the routing table 20. In addition, the bridge protocol processing routine 62 updates the contents of the parameter table 30 for each port, as necessary, according to the path setting by the STP.

A packet received from the wired LAN interface 14 is stored by the reception processing routine 65A into the reception buffer 19-0 provided for the port number 0 corresponding to the wired LAN interface 14. As indicated by a signal line 650, a reception event indicating the port number 0 is issued from the reception processing routine 65A to the bridge protocol processor 62.

In response to the reception event, the bridge protocol processor 62 reads the received packet from the reception buffer 19-0 corresponding to the port number 0 specified by the received event and searches the routing table 20 for the port number j corresponding to the destination address in the received packet. If the port number corresponding to the destination address in the received packet is not in the routing table 20, the received packet is discarded.

If the port number j corresponding to the destination address is found, the bridge protocol processor 62 stores the received packet into the transmission buffer 18-j with the port number j as a packet to be transmitted and then issues the transmission event indicating the port number j to the transmission processing routine 64B as indicated by a signal line 640. When the received packet is a multicasting-service packet, the packet is stored in the multicasting-service transmission buffer 18-1 and the transmission event indicating the port number 1 is issued.

On the other hand, when the MAC frame shown in FIG. 2 is received from the wireless interface (MAC controller 13), the reception processing routine 65B compares the forwarding destination address RA (Receiver Address) included in the MAC header of the received frame with a local bridge address 42 stored in the address table 40. If the RA matches the local bridge address, the reception processing routine 65B searches the parameter table 30 for the sub-table 30-k in which the connected bridge ID 35 matching the forwarding source address TA (Transmitter Address) included in the MAC header is stored, stores the packet extracted from the body frame field 120 of the received frame into the reception buffer 19-k having the port number k specified by the port ID 31 in the sub-table 30-k, and then issues the reception event indicating the port number k to the bridge protocol processor 62.

If the forwarding destination address RA included in the received frame does not match the local bridge address, the reception processing routine 65B compares the RA with the multicasting-service MAC addresses included in the table 41. If the RA matches one of the multicasting-service addresses included in the table, the reception processing routine 65B executes the same processing as it does for the received frame addressed to the local bridge; that is, it searches the parameter table 30 for the sub-table 30-k having the connected bridge ID 35 matching the forwarding source address TA, stores the packet extracted from the received frame into the reception buffer 19-k having the port number k specified by the port ID 31 in the sub-table 30-k and then issues the reception event indicating the port number k to the bridge protocol processor 62.

If the RA included in the received frame matches neither the local address nor any of the multicasting-service MAC addresses stored in the address table 40, the received frame is discarded.

For the received packet stored in the reception buffer with the port number k, the bridge protocol processor 62 performs the same processing as that for the received packet with the port number 0. Then, the multicasting-service received packet are stored in the LAN interface transmission buffer 18-0 with the port number 0 and the transmission event indicating the port number 0 is issued to the transmission processing routine 64B. For the multicasting-service packet taken out from the reception buffer 19-i (i=2-m), the copy is stored also in the transmission buffer 18-1 to allow the packet to be propagated to other wireless bridges.

FIG. 11 shows a flowchart showing the processing of the transmission processing routine 64 (64A, 64B) executed in response to a transmission event issued from the bridge protocol processor 62.

The transmission processing routine 64 reads a transmission packet from the transmission buffer 18-i with the port number i specified by the transmission event (step 641). If the port number i specified by the transmission event is the port number for the multicasting-service (=1) (step 642), the routine compares the destination address of the transmission packet (for example, Ethernet frame) with the multicasting or multicasting MAC addresses stored in the multicasting-service address table 41 (step 643). If they do not match, the routine performs no operation (discards the packet) and ends the transmission processing.

If the destination address matches one of broadcasting or multicasting MAC addresses, the transmission processing routine 64 creates a MAC frame that includes the destination address described above, that is, the broadcasting/multicasting address, in the DA address field 115 and the RA address field 113 of the MAC header 110 (step 644), transmits the created MAC frame to the MAC controller 13 (step 645), and ends the transmission processing. In this case, the local bridge address is set in the TA address field 114 of the MAC header, and the SA address attached to the transmission packet is set in the SA address field 117.

If the port number i specified by the transmission event matches one of wireless interface port numbers (=2-m) (step 646), the transmission processing routine 64 creates a MAC frame in which the MAC address indicated by the connected bridge ID 35 in the sub-table 30-i corresponding to the port number i is stored in the RA address field 113 (step 647), transmits the created MAC frame to the MAC controller 13 (step 645), and ends the transmission processing. In this case, the DA address of the transmission packet is stored in the DA address field 115 of the MAC header, and the same values as those stored in the multicasting-service MAC header are stored in the TA address field 114 and the SA address field 117.

If the port number i specified by the transmission event matches neither the multicasting service logical port number (=1) nor any of the other wireless interface logical port numbers (=2-m) (that is, the port number is 0 for the wired LAN interface in this embodiment), the transmission processing routine 64 transmits the transmission frame to the wired LAN interface 14 (step 649) and ends the transmission processing.

As described in the above embodiment, the wireless bridge according to the present invention selects connected bridges, which guarantee to give good communication quality, from the other neighboring wireless bridges, allocates logical port numbers to those connected bridges as the STP conforming bridges, and creates the parameter tables for use in STP forwarding control. The wireless bridge also allocates a logical port number dedicated to the multicasting service (broadcasting/multicasting) and transmits a broadcasting/multicasting packet via the dedicated port. Therefore, the wireless bridge in this embodiment reduces communication errors in the wireless section and transmits a multicasting service packet to a plurality of connected bridges at a time, thus greatly increasing message (packet) forwarding efficiency in the bridge protocol processor and in the wireless section.

In the embodiment shown in FIG. 10, the transmission buffer 18-i is provided for each port number i. Because the bridge protocol processor 62 issues a transmission packet and a transmission event indicating a port number as a pair, the transmission buffers 18-0 to 18-m shown in FIG. 10 may be grouped into one transmission packet queue in an actual application to allow the transmission processing routine 64 to alternately read a transmission event from the transmission event queue and a transmission packet from the transmission packet queue repeatedly.

Similarly, because the reception processing routine 65 issues a reception packet and a reception event indicating a port number as a pair, the reception buffers 19-0 and 19-2 to 19-m shown in FIG. 10 may be grouped into one reception packet queue to allow the bridge protocol processor 62 to alternately read a reception event from the reception event queue and a reception packet from the reception packet queue repeatedly.

In the embodiment, a wireless bridge with one wireless interface and one wired LAN interface is described. It is apparent that the present invention may be applied, for example, to a wireless bridge with a plurality of wireless interfaces implemented via frequency multiplexing.

Although a network segment, that is, a wired LAN, is built for each wireless bridge in the embodiment, the system may be configures such that at least one network segment is composed of a plurality of wireless terminals each communicating with a wireless bridge via radio waves. In addition, although the 802.1D protocol processing is executed in an IEEE802.11 wireless LAN in the embodiment, the present invention may be applied also to a protocol other than that used in the embodiment.

Because the connectable bridges are selected based on the communication quality to configure a wireless LAN in the embodiment described above, unnecessary traffic generated due to bad communications may be suppressed. The ability to transmit a multicasting service packet to a plurality of connected bridges at a time greatly increases message (packet) forwarding efficiency in the bridge protocol processor and in the wireless section.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A wireless bridging apparatus comprising:
a wireless interface for forwarding packets among network segments;
means for selecting, from other remotely-located wireless bridging apparatuses with which said wireless bridging apparatus can communicate, at least one connectable wireless bridging apparatus based on communication quality and for allocating logical port identifiers to connected wireless bridging apparatuses;
a plurality of transmission and reception buffers provided for the logical port identifiers;
a forwarding controller for forwarding a packet stored in each of the reception buffers to a transmission buffer identified by a destination address; and
means for transmitting and receiving packets to or from other network segments via said transmission and reception buffers and said wireless interface.

2. The wireless bridging apparatus according to claim 1, wherein said means for allocating logical port identifiers includes means for selecting wireless bridging apparatuses, each with a signal reception level higher than a pre-set threshold, from the remotely-located other wireless bridging apparatuses as the connectable wireless bridging apparatuses

3. The wireless bridging apparatus according to claim 2, wherein said means for allocating logical port identifiers includes means for selecting the connectable wireless bridging apparatuses from the remotely-located wireless bridging apparatuses, each with a signal reception level higher than the threshold, within a range not exceeding a pre-specified number.

4. The wireless bridging apparatus according to claim 3, further comprising a multicasting-service transmission buffer corresponding to a particular logical port identifier, wherein said means for transmitting and receiving packets transmits broadcasting or multicasting packets to other network segments using said multicasting-service transmission buffer.

5. The wireless bridging apparatus according to claim 2, further comprising a multicasting-service transmission buffer corresponding to a particular logical port identifier, wherein said means for transmitting and receiving packets transmits broadcasting or multicasting packets to other network segments using said multicasting-service transmission buffer.

6. The wireless bridging apparatus according to claim 1, further comprising a transmission buffer and a reception buffer provided for a port identifier allocated to a network segment associated with said wireless bridging apparatus.

7. The wireless bridging apparatus according to claim 1, further comprising a multicasting-service transmission buffer corresponding to a particular logical port identifier, wherein said means for transmitting and receiving packets transmits broadcasting or multicasting packets to other network segments using said multicasting-service transmission buffer.

8. A wireless bridging apparatus that allocates logical port identifiers to particular remotely-located wireless bridging apparatuses connected via a wireless interface and that controls a packet forwarding among network segments using the logical port identifiers, said apparatus comprising:
a plurality of transmission buffers and reception buffers provided for the logical port identifiers allocated to the particular remotely-located bridging apparatuses;
a transmission buffer provided for a logical port identifier allocated to a multicasting service;
a forwarding controller that forwards a packet stored in each of said reception buffers to a transmission buffer identified by a destination address; and
a transmission processor that adds a header, which is addressed to a corresponding remotely-located wireless bridging apparatus, to a transmission packet read from a transmission buffer corresponding to a port number of the particular remotely-located wireless bridging apparatus, that adds a multicasting-service header to a transmission packet read from a transmission buffer corresponding to the multicasting-service port identifier, and that transmits the transmission packet to said wireless interface.

9. The wireless bridging apparatus according to claim 8, wherein said transmission processor adds a MAC (Media Access Control) address to the transmission packet, said MAC address including an address of the particular remotely-located wireless bridging apparatus or a multicasting-service address as a forwarding destination address and an address of said wireless bridging apparatus as a forwarding source address.

10. The wireless bridging apparatus according to claim 9, further comprising a storage unit in which multicasting-service addresses are stored, wherein said transmission processor compares a destination address of a packet read from the transmission buffer corresponding to the multicasting-service port identifier with the multicasting-service addresses stored in said storage unit and, if a multicasting-service address match is found, adds the multicasting-service header to the transmission packet and transmits the transmission packet to the wireless interface.

11. The wireless bridging apparatus according to claim 9, further comprising:
a storage unit in which an address of said wireless bridging apparatus and multicasting-service addresses are stored; and
a reception processor that selectively stores a reception packet from said wireless interface into one of the reception buffers corresponding to a port identifier of the particular remotely-located wireless bridging apparatus;
wherein said reception processor compares a forwarding destination address included in a header of the reception packet with the addresses stored in the storage unit and stores the reception packet, whose forwarding destination address matches the address of said wireless bridging apparatus or one of the multicasting-service addresses, into the reception buffer corresponding to the port identifier of a neighboring wireless bridging apparatus that is a forwarding source of the packet.

12. The wireless bridging apparatus according to claim 8, further comprising a storage unit in which multicasting-service addresses are stored, wherein said transmission processor compares a destination address of a packet read from the transmission buffer corresponding to the multicasting-service port identifier with the multicasting-service addresses stored in said storage unit and, if a multicasting-service address match is found, adds the multicasting-service header to the transmission packet and transmits the transmission packet to the wireless interface.

13. The wireless bridging apparatus according to claim 8, further comprising:
a storage unit in which an address of the wireless bridging apparatus and multicasting-service addresses are stored; and
a reception processor that selectively stores a reception packet from said wireless interface into one of the reception buffers corresponding to a port identifier of the particular remotely-located wireless bridging apparatus;
wherein said reception processor compares a forwarding destination address included in a header of the reception packet with the addresses stored in the storage unit and stores the reception packet, whose forwarding destination address matches the address of said wireless bridging apparatus or one of the multicasting-service addresses, into the reception buffer corresponding to the port identifier of a neighboring wireless bridging apparatus that is a forwarding source of the packet.

14. The wireless bridging apparatus according to claim 8, further comprising a transmission buffer and a reception buffer provided for the port identifier allocated to the network segment of said wireless bridging apparatus.

15. A wireless bridging apparatus comprising:
a wireless interface for use in packet communication in a MAC frame format in a wireless section between network segments in accordance with IEEE802.11;
a manager that manages a network topology in accordance with a spanning tree protocol defined by IEEE802.1D; and
a transmitter that adds a MAC header to a packet to be broadcast or multicast to a plurality of remotely-located wireless bridging apparatuses and transmits the packet from said wireless interface as a multicasting-service packet, said MAC address including a broadcasting address or a multicasting address as a forwarding destination address.

16. The wireless bridging apparatus according to claim 15, further comprising a selector that selects wireless bridging apparatuses, each with communication quality at a predetermined level or higher, from other wireless bridging apparatuses, which are located in a range where said wireless bridging apparatus can communicate, as connectable bridging apparatuses to which the spanning tree protocol is applied.

17. The wireless bridging apparatus according to claim 15, wherein said manager transmits and receives a BPDU (Bridge Protocol Data Unit) frame to or from other wireless bridging apparatuses to identify a network topology.

18. The wireless bridging apparatus according to claim 15, further comprising an interface for the network segments.

19. A wireless packet forwarding method using a wireless bridging apparatus, comprising the steps of:
selecting wireless bridging apparatuses, each with communication quality at a predetermined level or higher, from other wireless bridging apparatuses, which are located in a range where said wireless bridging apparatus can communicate, as wireless bridging apparatuses to which a spanning tree protocol is applied;
adding a MAC header to a packet to be transmitted to a plurality of wireless bridging apparatuses through a multicasting service, said MAC header including a broadcasting address or a multicasting address as a forwarding destination address; and
transmitting the packet from a wireless interface of said wireless bridging apparatus as a multicasting-service packet.
